(19) United States
(12) Patent Application Publication
(10) Pub. No.: US 2011/0248945 A1
(43) Pub. Date: Oct. 13, 2011

(54) MOBILE TERMINAL

(76) Inventor: Takashi Higashitani, Osaka (JP)

(21) Appl. No.: 13/126,883

(22) PCT Filed: Oct. 26, 2009
(86) PCT No.: PCT/JP2009/068344

§ 371 Date: Apr. 29, 2011

(30) Foreign Application Priority Data
Oct. 29, 2008 (JP) 2008-277616

(51) Int. Cl. G06F 3/041

(52) U.S. Cl. 345/173

(57) ABSTRACT

A mobile terminal (10) includes an LCD monitor (28), and the display region of the LCD monitor (28) includes a character display region (44) wherein character strings or the like representing a mail body can be displayed and a virtual keyboard display region (46) wherein a hiragana character virtual keyboard or the like can be displayed. On the upper surface of the LCD monitor (28), a touch panel (36) is provided, and the touch panel (36) detects touch manipulation on the character display region (44) or the like. By sliding a finger on the character display region (44), the selected position can be moved in the virtual keyboard, and the character corresponding to the character key indicated by the selected position, i.e., the focused character key is displayed in the character display region (44).

### TECHNICAL FIELD

This invention relates to mobile terminals, and more particularly relates to, for example, a mobile terminal with a touch panel which is used for inputting characters.

### BACKGROUND ART

Conventionally, mobile terminals with a touch panel which is used for inputting characters are well-known and one example of this type of devices is disclosed in non-patent document 1. The background technology is such that it is possible to input characters in an iPhone (registered trade mark) equipped with a touch panel by tapping (lightly tap the touch panel), dragging (vertically or horizontally shifting a finger while touching the touch panel), or flicking (flicking a screen on the touch panel) with respect to an on-screen keyboard that is displayed on a screen. For inputting Japanese using an on-screen keyboard, there are a full keyboard input method and a numerical keypad input method.

When, for example, inputting characters with using a memo function and the like, a character display region in which input characters are displayed, and a keyboard display region in which an on-screen keyboard is displayed, are displayed on a screen. In addition, a keyboard with a QWERTY arrangement is displayed in the keyboard display region and it is possible to input Japanese or Hiragana characters by inputting Roman characters. The input of the numerical keypad method is a character input method used in conventional mobile phones, and a numerical keypad from “a” column to “wa” column is displayed in the keyboard display region. Moreover, when inputting “i”, the key of “a” is tapped twice.

Furthermore, for input with the numerical keypad method, if a numerical keypad is tapped and held as tapped for approximately one second, character candidates appear in the directions of a cross; therefore, by sliding a finger and removing the finger away from it, the character in the slid direction can be input. For example, if a key of “a” is left as having been tapped for approximately one second, “i” in the left direction, “u” in the upward direction, “e” in the right direction, and “o” in the downward direction are displayed. For example, “i” is input by sliding in the left direction.

In addition, in the related art disclosed in the Patent Document 1, there are mobile phones comprising a display screen that displays a virtual keyboard, and a touch pad. A user is able to move a selection candidate key on the virtual keyboard by operating the touch pad, and select a key which is a candidate key at last when a finger leaves from the touch pad.

### RELATED ART DOCUMENT(S)

### Patent Document(s)

Non-patent document 1: 3G complete guide, issued by Mainichi Communications Inc. (page 14 to 15)
Patent Document 1: Japanese Patent Laid Open Publication No. 2003-196007 [G06F 3/023, H03M 11/04]

For the full keyboard input described in the Non-patent document 1, because keys displayed on a screen are small, there are cases in which a wrong character is input. If the display of keys is made so as to be larger, a region in which input characters are displayed becomes small; thus, making it difficult to input a long sentence such as an email. For the numerical pad input, because the number of keys to be displayed is small, likelihood of inputting a wrong character is reduced; however, because tapping a plurality of times or a single tapping is required to input one character before sliding a finger, the operation is complicated. If a plurality of characters are assigned to one key, for cases of Hiragana, closely related characters in the same column may be assigned; however, alphabets or symbols and the like have less relation with other characters; hence, they are not suitable for inputting alphabets or symbols using a numerical keypad.

In the Non-patent document 1, a touch pad for operating a virtual keyboard cannot be provided in an overlapping manner in the display part such as a touch panel; therefore, providing a touch pad makes the size of a mobile phone larger. If a finger is removed from the touch pad, the character is determined; therefore, a character one wishes to input must be selected with one operation. Therefore, as the number of keys included in the virtual keyboard increases, the relative ratio of the amount of shift within the virtual keyboard becomes greater with respect to the amount of a finger shift, thus, making it difficult to select each key.

### SUMMARY OF THE INVENTION

An object of the present invention is to provide a character display program that is applied to a novel mobile terminal or a processor used in such a mobile terminal.

Another object of the present invention is to provide a character display program capable of easily and accurately inputting characters and that is applied to a mobile terminal or a processor used in such a mobile terminal.

In order to solve the above problems, a mobile terminal according to an embodiment of the present invention comprises a display device, touch operation detection means, touch operation detection means, character selection means, and character display control means. The display comprises a first display region operable to display a string of characters and a second display region operable to display a virtual keyboard. The touch operation detection means detects a touch operation in the touch response region provided with the display device. The character selection means selects a character in the virtual keyboard based on the touch operation detected by the touch operation means. The character display control means displays the character that is selected by the character selection means in the first display region.

According the above mentioned apparatus, a user may easily select a character of a virtual keyboard with a touch operation and accurately input a character.

### BRIEF DESCRIPTION OF THE DRAWINGS

FIG. 1 is a block diagram showing a mobile terminal according to the present invention.

FIG. 2 is a drawing of a graphic representation showing the appearance of the mobile terminal that is shown in FIG. 1.

FIG. 3 is a drawing of a graphic representation showing one example of a state in which a virtual keyboard is displayed on an LCD monitor that is shown in FIG. 1.

FIG. 4 is a drawing of a graphic representation showing one example of an operation procedure with respect to the touch panel that is shown in FIG. 1.

FIG. 5A is another drawing of a graphic representation showing one example of an operation procedure with respect to the touch panel that is shown in FIG. 1.

FIG. 5B is another drawing of a graphic representation showing one example of an operation procedure with respect to the touch panel that is shown in FIG. 1.

FIG. 6 is another drawing of a graphic representation showing one example of an operation procedure with respect to the touch panel that is shown in FIG. 1.

FIG. 7 is a drawing showing one example of a state in which a virtual keyboard is displayed on an LCD monitor that is shown in FIG. 1.

FIG. 8A is a drawing showing one example of a state in which a virtual keyboard is displayed on an LCD monitor that is shown in FIG. 1.

FIG. 8B is a drawing showing one example of a state in which a virtual keyboard is displayed on an LCD monitor that is shown in FIG. 1.

FIG. 9A is a drawing showing one example of a type of a virtual keyboard used in the mobile terminal that is shown in FIG. 1.

FIG. 9B is a drawing showing one example of a type of a virtual keyboard used in the mobile terminal that is shown in FIG. 1.

FIG. 10 is a drawing showing one example of a memory map of a RAM that is shown FIG. 1.

FIG. 11 is a flow diagram showing a virtual keyboard control process of a CPU that is shown in FIG. 1.

FIG. 12 is a flow diagram showing a vector detection process of a CPU that is shown in FIG. 1.

FIG. 13 is a flow diagram showing a selection position shift process of a CPU that is shown in FIG. 1.

FIG. 14 is another drawing showing one example of a type of a virtual keyboard used in the mobile terminal that is shown in FIG. 1.

### REFERENCE NUMERALS

10 mobile terminal
20 CPU
22 key input device
24 character generator
28 LCD monitor
32 RAM
34 touch panel control circuit
36 touch panel

### EMBODIMENTS CARRYING OUT THE INVENTION

### First Embodiment

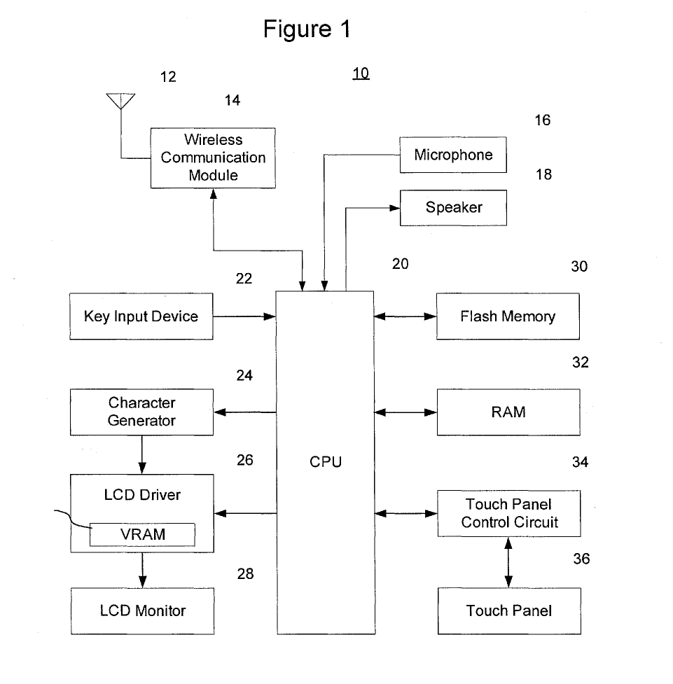

Referring FIG. 1, a mobile terminal 10 includes a CPU (also referred as a processor or a computer) 20, a key input device 22, and a touch panel 36 that is controlled by a touch panel control circuit 34. The CPU 20 controls a wireless communication circuit 14 and outputs the calling signals. The calling signals that are output are transmitted from an antenna 12 to a mobile communication network including a base station. When a communicating partner performs a response operation, a call-capable state is established.

After moving into the call-capable state, when an operation to end the call is performed with a key input device 22 or the touch panel 36, the CPU 20 controls the wireless communication circuit 14 and transmits the call end signals to the communicating partner. After the call end signals are transmitted, the CPU 20 ends the call process. Even in cases in which the call end signals are received first from the communicating partner, the CPU 20 ends the call process. Regardless of a communicating partner, even in cases in which the call end signals are received from a mobile communicating network, the CPU 20 ends the call process.

In the state in which the mobile terminal 10 is running, if the calling signals from the communicating partner are received by the antenna 12, the wireless communication circuit 14 notifies the CPU 20 of the incoming call. The CPU 20 causes the LCD monitor 28, which is a display device, to display information regarding the transmission source that is described in the incoming call alert. The CPU 20 further causes a speaker for incoming call alert, which is not illustrated, to output the incoming call tone.

In the call-capable state, the following processes are executed. The modulated voice signals (high frequency signals) sent from the communicating partner is received by the antenna 12. The modulated voice signals that are received are subjected to demodulation processing or decoding processing by the wireless communication circuit 14. The received voice signals that are obtained based on these are output from a speaker 18. The transmitting voice signals captured by a microphone 16 are subjected to encoding processing and modulation processing by the wireless communication circuit 14. Based on these, the modulated voice signals generated are transmitted to the communicating partner using the antenna 12, as described above.

The touch panel 36 that functions as a touch operation detection means is a pointing device for a user to provide an instruction of an arbitrary position within the LCD monitor 28 screen. When the top surface is operated with a finger by pressing, sliding (stroking), or touching, the touch panel 36 detects the operation. When the touch panel 36 detects the touch, a touch panel control circuit 34 determines the position of the position and outputs the coordinate data of the operation position to the CPU 20. That is, the user is able to input the direction of an operation, a graphic or the like to the mobile terminal 10 by pressing, sliding, or touching the top surface of the touch panel 36 with the finger.

The touch panel 36 is a method, namely capacitance method that detects changes in capacitance between electrodes, caused when the finger approaches the surface of the touch panel 36, and detects that one or a plurality of fingers have touched the touch panel 36. For this touch panel 36, more specifically, a projection type capacitance method that detects changes in capacitance between the electrodes, caused when the finger approaches by forming an electrode pattern to a clear film and the like is used. Moreover, for a detection method, a surface type capacitance method may be used, and it may be a resistance film method, an ultrasound method, an infrared method, an electromagnetic induction method or the like.

Here, an operation by which a user touches the top surface of the touch panel 36 with the finger is referred to as a “touch”. On the other hand, an operation of removing the finger away from the touch panel 36 is referred to as a “release”. An operation to rub the surface of the touch panel 36 is referred to as a slide. A coordinate indicated by the touch is referred to as a “touch point” and a coordinate of the final position of an operation indicated by the release is referred to as a “release point”. An operation for a user to touch the top surface of the touch panel 36 and subsequently to release is referred to as a “touch-and-release”. Operations performed such as touch, release, slide, and touch-and-release with respect to the touch panel 36 are generally called “touch operations”. Operations with respect to the touch panel 36 may be performed not only with the finger but also with a stick having a shape in which the tip is narrow such as a pen. A special touch pen or the like may be provided in order to carry out the operations. For the touch point for cases in which touching is performed using a finger, the center of gravity in the area of the finger that is in contact with the touch panel 36 becomes the touch point.

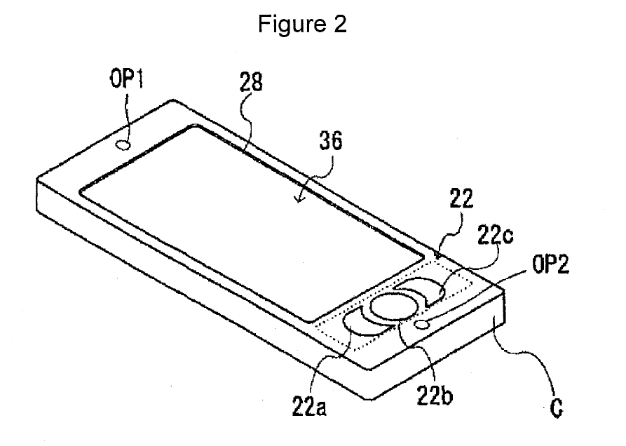

FIG. 2 is a drawing of a graphic representation showing the appearance of the mobile terminal 10 that is shown in FIG. 1. Referring FIG. 2, the mobile terminal 10 has a case C that is formed in a plate shape. The microphone 16 which is not shown in FIG. 2 and the speaker 18 are internally mounted in the case C. An opening OP 2 leading to the internally mounted microphone 16 is provided on one main surface of the case C in the longitudinal direction and the opening OP 1 leading to the internally mounted speaker 18 is provided on the other main surface of the case C in the longitudinal direction. That is, the user listens to sound output from the speaker 18 via the opening OP 1 and inputs the voice to the microphone 16 through the opening OP 2.

A key input device 22 includes 3 types of keys, namely a talk key 22a, a menu key 22b, and a talk end key 22c, and the respective keys are provided on the main surface of the case C. The LCD monitor 28 is mounted such that the monitor screen is exposed to the main surface of the case C. Furthermore, the touch panel 36 is provided on the top surface of the LCD monitor 28.

The user performs a response operation by operating the talk key 22a and performs a call end operation by operating the talk end key 22c. In addition, the user causes the LCD monitor 28 to display a menu screen by operating the menu key 22b. Then, an operation to switch on/off the power of the mobile terminal 10 is performed by pressing the talk end key 22c longer.

Furthermore, this mobile terminal 10 is provided with an email function, and in this email function, characters can be input with composing a new email or creating a reply email. Furthermore, for the mobile phone 10, characters can also be input with other functions such as an address book edit function, a memo book function and the like, for example. Here, characters are input using the virtual keyboard that is displayed on the LCD monitor 28 rather than using keys provided in the key input device 22.

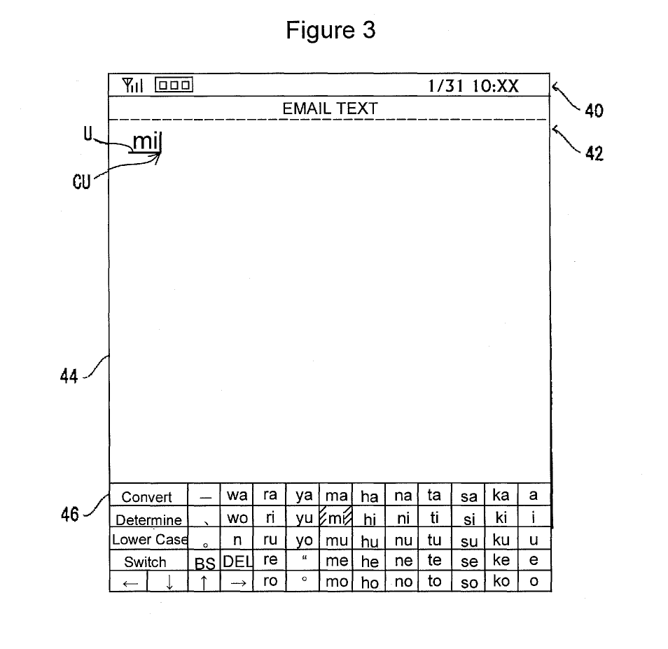

FIG. 3 is a drawing of a graphic representation showing one example of a state in which a virtual keyboard is displayed on an LCD monitor 28 that is shown in FIG. 1. The LCD monitor 28 includes a state display region 40 and a function display region 42. In the present embodiment, the entire surface of the LCD monitor 28, as described above, is covered with the touch panel 36. However, the present invention is not limited to such cases and it may be such that some of the surface of the LCD monitor 28 is covered with the touch panel 36.

To the state display region 40, a radio wave receiving state by the antenna 12, remaining battery balance of a rechargeable battery, a current date/time and the like are displayed. To the function display region 42, images or a string of characters of functions executed with the mobile terminal 10 are displayed. In FIG. 3, an email text composition screen with the email function is displayed. The function display region 42 in which the email text composition screen is displayed is constituted from two more display regions. First, to a character display region 44, which is a first display region, an email text is displayed. Then, to a virtual keyboard display region 46, which is a second display region, a virtual keyboard for inputting characters is displayed. Here, the origin of the character display region 44 and the virtual keyboard display region 46 is defined to be at the upper left end. That is, the lateral coordinate becomes greater as it progresses from the upper left end to the upper right end, and the ordinate becomes greater as progresses from the upper left end to the lower left end.

In an initial state of the virtual keyboard, it is in a state in which a character key of “mi” is selected, and the background color of the character key of “mi” in the virtual keyboard is colored in yellow. A character corresponding to a character key that is selected in the virtual keyboard is displayed in the character display region 44 as a character being selected. The selection of a character key in the virtual keyboard is referred to as a “focus”, and the position of the character key to be focused is referred to as a selection position. Moreover, the background color of a character key in a normal state is colored in gray. An underline U is added to “mi” that is displayed in the character display region 44 so as to indicate that the character is being selected.

The state display region 40 shown in FIG. 3, the function display region 42, the character display region 44, the virtual keyboard display region 46, a cursor CU and the underline U are the same in other drawings; therefore, in other drawings, detailed explanations are omitted for simplification purposes. The virtual keyboard shown in FIG. 3 is also referred to as a Hiragana virtual keyboard at times.

Here, in order to focus on a character key other than “mi” that is in the virtual keyboard, it may be slid with respect to the character display region 44.

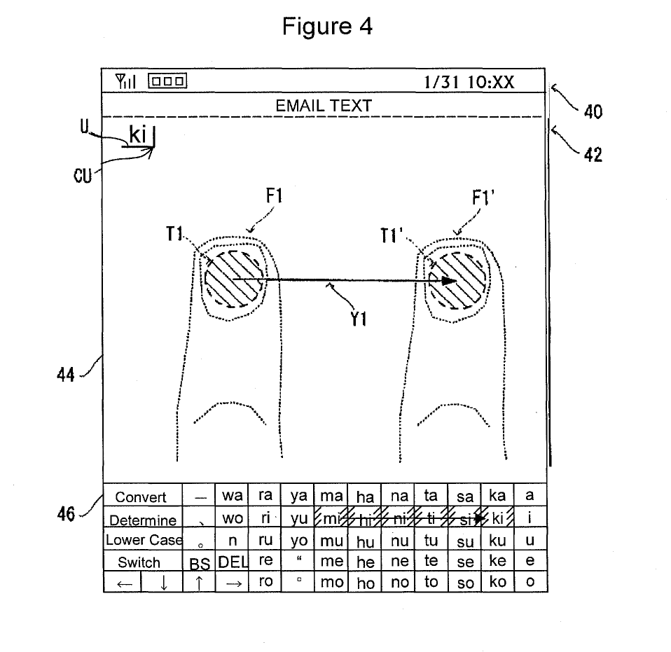

FIG. 4 is a drawing of a graphic representation showing one example of an operation procedure with respect to the touch panel that is shown in FIG. 1. Referring to FIG. 4, a finger F1 performs the touch with respect to the character display region 44. The touch range T1 indicates the range in which the touch panel 36 is in contact resulting from the touch of the finger F1. The finger F1′ also shows a state after the finger T1 slides from the left side to the right side. That is, FIG. 4 shows a sliding operation from the left side to the right side with respect to the character display region 44. An arrow Y1 in the right direction shows a vector corresponding to the slide.

The vector shown by the arrow Y1 or the shift of the slide (amount of the slide) can be calculated using the theorem of three squares of coordinates of the touch point, the current touch position, or the release point, and the shifting direction of the selection position can be calculated from the direction of the vector. When calculating, from the amount of the slide, the number of shifts of the shift positions (number of selection shifts), it can be calculated using an equation shown in Equation 1.

Amount of the slide/Converted value=Number of selection shifts [EQUATION 1]

As the finger F1 and the finger F1′ shown in FIG. 4, for example, show, when it slides from the left side to the right side, the selection position shifts to the right side. At this time, when the amount of the slide vector shown by the arrow Y1 is 250 and when the converted value is 50, the number of the selection shifts is, based on the Equation 1, calculated to be 5. Because the vector shown by the arrow Y1 is in the right direction, the selection position shifts by 5 to the right. That is, a character to be focused changes from “mi” to “ki”.

When the selection position shifts, the background color of the respective character key of the focused character key, namely “mi”, “hi”, “ni”, “chi”, and “shi” is colored in pale yellow. A character being selected is updated each time when the selection position shifts. In other words, if a character focused in the virtual keyboard is updated in the order of “mi”, “hi”, “ni”, “chi”, “shi”, in the character display region 44, it is displayed in the order of “ki”, the “mi”, “hi”, “ni”, “chi”, “shi”, and “ki”. The CPU 20 controls a character generator 24 and an LCD driver 26 in order to sequentially display a character being selected. Specifically, the CPU 20 provides an instruction to the character generator 24 to generate character image data of a character being selected, and subsequently, provides an instruction to the LCD driver 26 to display the character being selected. When the instruction is provided from the CPU 20 to generate the character image data of the character being selected, the character generator 24 generates character image data that corresponds to the character being selected and stores in a VRAM 26a that is internally mounted in the LCD driver 26. Next, when an instruction is provided to display the character being selected from the CPU 20, the LCD driver 26 displays the character image data stored in the VRAM26a is displayed on the LCD monitor 28. Thus, when the characters being selected are sequentially displayed, the character image data to be stored in the VRAM 26a is updated.

In this manner, when a sliding operation is performed, in order to sequentially display characters being displayed, the mobile terminal 10 can sequentially verify each of the selected characters.

The character key with the background color colored in pale yellow returns to gray after a predefined time (approximately one second) passes. For a unit of the sliding amount, millimeter (mm), inch (inch), dot (dot) or the like may be used. The converted value may be set arbitrarily by the user. As the number of the selection shifts in the longitudinal directions is different from the number of the selection shifts in the lateral directions, it may be set so as to have converted values for the longitudinal direction and the converted value for the lateral direction. Thus, the fingers F1 and F1′ that are shown in FIG. 4, and the touch ranges T1 and T1′ are the same in other drawings; therefore, in other drawings, detailed explanations are omitted for simplification purposes.

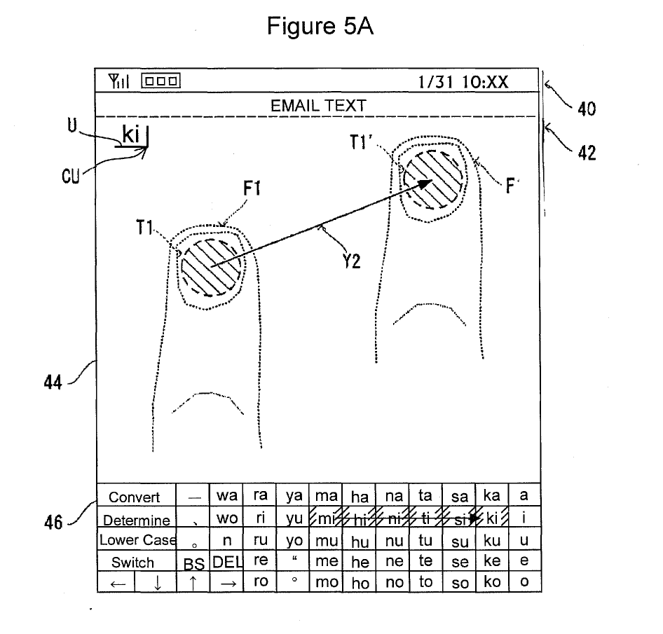

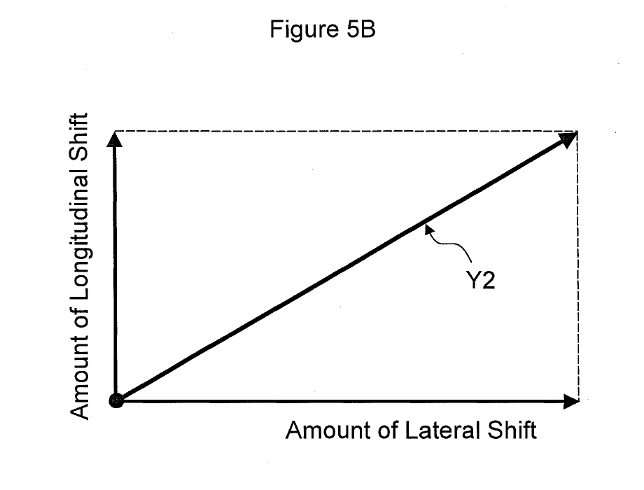

FIGS. 5A and 5B are drawings of a graphic representation showing processes for correcting the direction of a vector corresponding to a slide in the diagonal direction to a vector in the lateral direction or the longitudinal direction is described. Referring to FIG. 5A, the fingers F1 and F1′ show an operation in which after it is touched with the finger F1, it is slid in the right diagonal upward direction. A vector shown by an arrow Y2 in the right diagonal upward direction or a shift of a vector may be broken down to the amount of a lateral shift in the right direction and the amount of a longitudinal shift in the upward direction as shown in FIG. 5B. By comparing the absolute values of the amount of the lateral shift and the amount of the longitudinal shift, the direction of the vector is corrected in the direction shown by the greater amount of shift, and based on the greater amount of shift, the number of the selection shifts is calculated. In FIG. 5B, for example, the amount of the lateral shift is greater between the amount of the longitudinal shift and the amount of the lateral shift; hence, the vector shown by the arrow Y2 is corrected in the horizontal direction and the number of the selection shifts is calculated based on the amount of the lateral shift.

If the absolute values of the amount of the lateral shift and the amount of the longitudinal shift are the same, the number of the selection shifts is not calculated. That is, the direction of the vector is not corrected and the shift position is not shifted. This is because when the absolute values of the amount of the lateral shift and the amount of the longitudinal shift are the same, the angle of the vector with respect to the horizontal axis is 45 degrees; therefore, the CPU 20 is not able to clearly determine whether the sliding operation is intended in the lateral direction or intended in the longitudinal direction.

In this manner, because for the mobile terminal 10, with regard to the sliding operation, the direction of the vector is limited to be either in the lateral direction or in the longitudinal direction, an incorrect operation can be prevented at the time of selecting a character key in the virtual keyboard.

Based on the ratio of the amount of the lateral shift and the amount of the longitudinal shift, the direction of the vector may be corrected. More specifically, according to the Equation shown in Equation 2, the ratio of the amount of the lateral shift to the amount of the longitudinal shift is calculated, and if the ratio exceeds 1, the vector is corrected in the longitudinal direction. In contrast, if the ratio is a decimal number, that is, if the ratio is less than 1 the vector is corrected in the lateral direction. If the ratio is 1, because the angle of the vector with respect to the horizontal axis is 45 degrees, the number of the selection shifts is not calculated.

Amount of longitudinal shift/amount of lateral shift=Ratio [EQUATION 2]

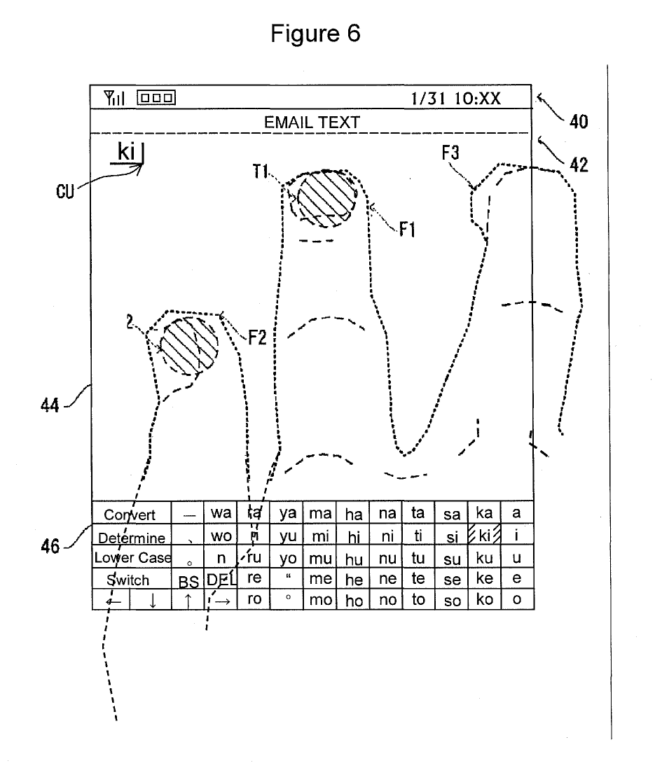

FIG. 6 is a drawing of a graphic representation showing a process for determining a selected character. Referring FIG. 6, in the state in which it is touched with the finger F1, and furthermore, when a touch range T2 is shown with the finger F2, a character being selected, namely “ki” is determined and the under line U disappears. In addition, the background color of the character key of “ki” in the virtual keyboard is colored in red and shows that the character “ki” is determined. Then, the determined character is stored in a RAM 32 as email text data. Here, an operation of sliding and subsequently touching a second point in order to determine a character is referred as a “determining operation”.

In this manner, because a character being selected can be determined by subsequently touching after sliding, using the touch panel 36, a character being selected can be easily determined. Also, by determining the character being selected, the plurality of characters can be continuously input; therefore, the user can compose sentences.

The character key with the background color being colored in red, as is the case with the character key with the background color colored in pale yellow, returns to gray after a predefined time passes. The position to be touched with the finger F2 in the determining operation is not limited to the character display region 44, and it may be within any display regions of the virtual keyboard display region 46 and the state display region 40. As for other determining operation, in the state in which an arbitrary character being selected is displayed, a character being selected may be determined by operating the menu key 22b or the like. For example, when using a touch panel that cannot detect a simultaneous touch at two points, the menu key 22b may be used for the determining operation.

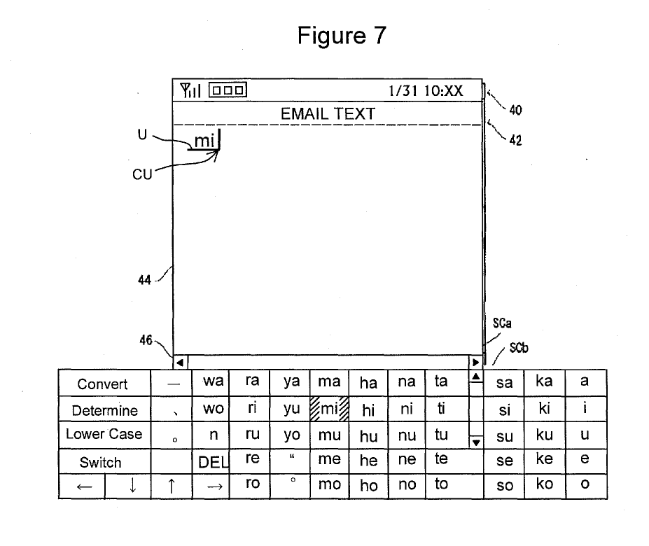

FIG. 7 is a drawing of a graphic representation showing one display example in which a display size of the virtual keyboard is changed. Referring FIG. 7, some of the virtual keyboard is displayed in the virtual keyboard display region 46. Character keys not displayed in the virtual keyboard display region 46 are shown by dotted lines. In order to indicate that some of the virtual keyboard is not displayed, a horizontal scroll SCa and a vertical scroll SCb are displayed, within the respective scrolls, the position of the virtual keyboard that is being displayed is shown; therefore, a scroll bar is included.

In other words, the user is not able to visually recognize the character keys shown in the dotted lines with the eyes. Therefore, here, such that the character keys shown in the dotted lines can be recognized visually, the display of the virtual keyboard is scrolled. A procedure of scrolling the display of the virtual keyboard is described below.

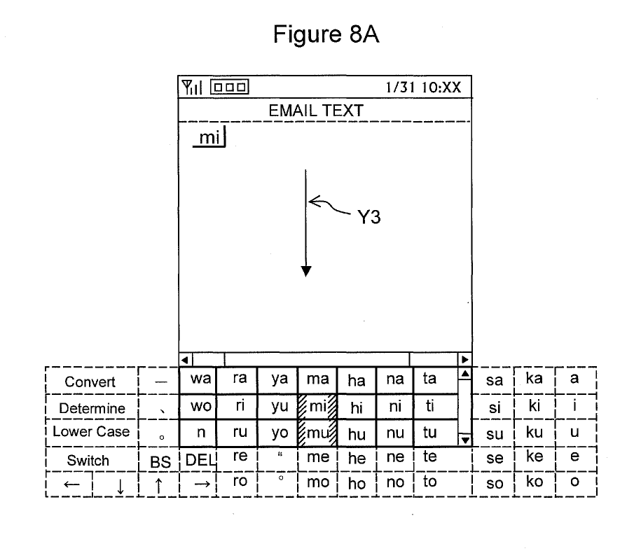

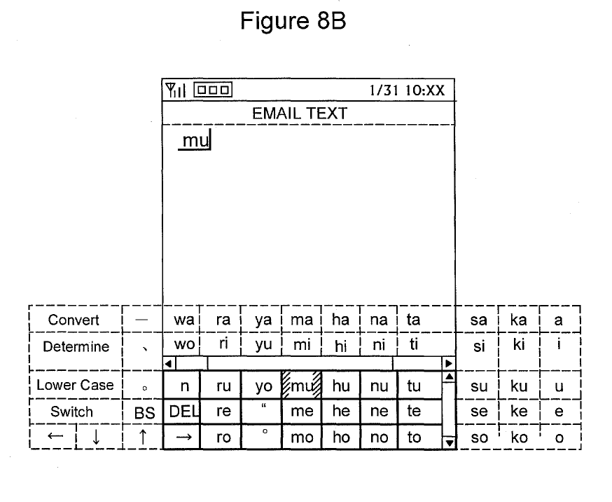

FIGS. 8A and 8B are drawings of graphic representation showing a process for scrolling a display on a virtual keyboard. The state display region 40, the function display region 42, the character display region 44, the virtual keyboard display region 46, the cursor CU, the underline U, the arrows showing the horizontal scroll SCa and the vertical scroll SCb are omitted. Referring FIG. 8A, when the vector is shown in an arrow Y3 in the downward direction, a character key to be focused shifts from “mi” to “mu”. The character key of this “mu” is a character key to be displayed at one end of the virtual keyboard display region 46 and the direction of the vector is in the downward direction; therefore, the display of the virtual keyboard scrolls in the downward direction. That is, as shown in FIG. 8B, a character key group in two rows located below the character key “mu” is displayed in the virtual keyboard display region 46 and a character key group in two rows located above the character key “mu” is no longer displayed in the virtual keyboard display region 46. In addition, a scroll bar within the vertical scroll SCb shifts in the downward direction.

In other words, when the focused character key is a character key that is displayed at one end of the virtual keyboard display region 46, a scrolling direction is determined based on the direction of the vector and the display of the virtual keyboard is scrolled.

In the state in which the character key of “mu” is being selected, if the direction of the vector is in the upward direction, as is the case with a virtual keyboard shown in FIG. 8A, a group of character keys in two rows located above the character key of “mu” is displayed in the virtual keyboard display region 46 and a group of character keys in two rows located below the character key of “mu” is no longer displayed in the virtual keyboard display region 46 as shown in FIG. 8B. In addition, the scroll bar within the vertical scroll SCb shifts in the upward direction.

Moreover, in the state shown in FIG. 8A, in the state in which any one of character keys, namely “ta”, “chi” or “tsu” is being focused, if the direction of the vector is in the right direction, a character key group in three rows located to the right of the focused character key is displayed in the virtual keyboard display region 46 and a character key group in three rows on the right from one end of the left side of the virtual keyboard display region 46 is no longer displayed. In addition, the scroll bar within the horizontal scroll SCa shifts in the right direction.

Then, in the state shown in FIG. 8A, in the state in which any one of character keys, namely “wa”, “wo” or “n” is being focused, if the direction of the vector is in the left direction, a character key group in two rows located to the left of the focused character key is displayed in the virtual keyboard display region 46 and a character key group in three rows on the left from one end of the right side of the virtual keyboard display region 46 is no longer displayed. In addition, the scroll bar within the horizontal scroll SCa shifts in the right direction.

In this manner, even by enlarging the display size of the virtual keyboard so as to display some part thereof, the display may be scrolled. That is, with the mobile terminal 10, such that the user can easily use, the display size of the virtual keyboard may be enlarged.

Here, In the state of the display size of the virtual keyboard shown in FIG. 7, when the touch-and-release is performed with respect to the character display region 44, the display size is changed to the display size of the virtual keyboard shown in FIG. 3. That is, the display size of the virtual keyboard becomes smaller. In the state of the display size of the virtual keyboard shown in FIG. 3, after a touch-and-release is performed with respect to the character display region 44, the display size returns to the display size of the virtual keyboard shown in FIG. 7. That is, the display size of the virtual keyboard becomes larger. The position of the touch-and-release may be within the virtual keyboard display region 46.

In other words, with this mobile terminal 10, each time the character display region 44 is touched and released, the display size of the virtual keyboard switches; therefore, the user is able to select a display size of the virtual keyboard such that the user himself/herself can easily use it.

The number of the selection shifts may be changed according to the display size. When the display size of the virtual keyboard increases, for example, the number of the selection shifts with respect to the amount of slide is set so as to be great. When the display size of the virtual keyboard decreases, the number of the selection shifts with respect to the amount of slide is set so as to be less.

The display size of the virtual keyboard is not limited to two, and it may be set such that each time the character display region 44 is touched and released, the display size may be increased gradually. In this case, in the state in which the display size is the maximum size, and when the touch and release is performed, it may be set such that the display size returns to the minimum state. Moreover, by touching simultaneously so as to pick two points on the upper right and the lower left of the virtual keyboard display region 46 and by sliding the two points into the center of the virtual keyboard display region 46, the display size of the virtual keyboard may be made so as to be small. In contrast, by touching so as to pick two points in the center of the virtual keyboard display region 46 and by sliding the two points on the upper right and the lower left of the virtual keyboard display region 46, the display size of the virtual keyboard may be made so as to be larger.

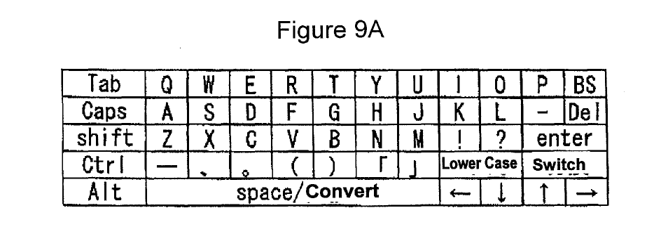

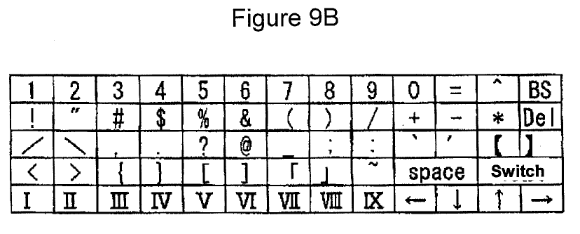

FIGS. 9(A) and (B) are drawings of graphic representation showing another virtual keyboard. An alphabetic virtual keyboard shown in FIG. 9(A) is used for inputting alphabets and a numerical/symbol virtual keyboard shown in FIG. 9(B) is used for inputting numerals or symbols. When a switch key included in each virtual keyboard is selected and when the determining operation is performed, it is possible to switch the Hiragana virtual keyboard, the alphabetic virtual keyboard, and the numerical/symbol virtual keyboard, which are shown in FIG. 3 and the like, in this order.

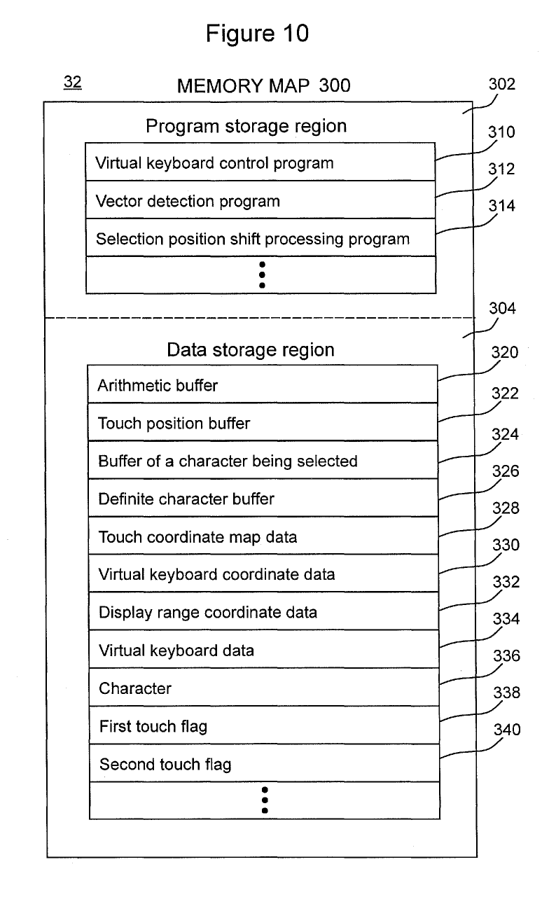

FIG. 10 is a drawing of graphic representation showing a memory map of a RAM 32. Referring FIG. 10, a memory map 300 of the RMA 32 includes a program storage region 302 and a data storage region 304. Some of programs or data is read out from a flash memory 30 all together or partially and sequentially as necessary, stored in the RAM 32, and processed by the CPU 20 or the like.

The program storage region 302 stores programs for operating the mobile terminal 10. The program for operating the mobile terminal 10 is constituted from a virtual keyboard control program 310, a vector detection program 312, a selection position shift process program 314 and the like.

The virtual keyboard control program 310 is a program for changing the character input and the display size using the virtual keyboard. The vector detection program 312 is a sub-routine of the virtual keyboard control program 310 and is a program for correcting the direction of the vector resulting from sliding. The selection position shift process program 314 is a sub-routine of the virtual keyboard control program 310 and is a program for calculating the number of the selection shifts from the sliding amount and for controlling the scroll of the virtual keyboard.

Although the illustration is omitted, the program for operating the mobile terminal 10 includes a calling control program, an email function control program and the like.

The data storage region 304 is provided with an arithmetic buffer 320, a touch position buffer 322, a buffer for a character being selected 324, and a definite character buffer 326. The data storage region 304 stores a touch coordinate map data 328, a virtual keyboard coordinate data 330, a display range coordinate data 332, a virtual keyboard data 334, and a character data 336, and is provided with a first touch flag 338, a second touch flag 340 and the like.

The arithmetic buffer 320 is a buffer for temporarily storing results of calculation that is processed while a program is being executed. The touch position buffer 322 is a buffer for temporarily storing input results detected by the touch panel 36 such as touching, and for example, temporarily stores coordinate data of a touch point or a release point. The buffer for a character being displayed 324 is a buffer for temporarily storing character data that corresponds to a character key that is focused in the virtual keyboard. The buffer for character decision 326 is a buffer for temporarily storing character data of a determined character that is being selected.

The touch coordinate map data 328 is data for mapping a coordinate such as a touch point with respect to the touch panel 36 specified by the touch panel control circuit 34 to the display position of the LCD monitor 28. That is, the CPU 20 is capable of mapping the results of the touch operation performed with respect to the touch panel 36 and the display of the LCD monitor 28 based on the touch coordinate map data 328.

The virtual keyboard coordinate data 330 includes coordinate data of each of character keys in the virtual keyboard. Thus, as shown in FIG. 7, the virtual keyboard coordinate data 330 includes coordinate data of character keys that are not in the displayed section even if it is a virtual keyboard in which only some of it is displayed. The display range coordinate data 332 is coordinate data of a virtual keyboard that is displayed in the LCD monitor 28. Therefore, as shown in FIG. 7, coordinate data of character keys of a section that is not displayed is not included. The virtual keyboard data 334 is constituted of data such as the Hiragana virtual keyboard that is shown in FIG. 3 and the like, the alphabetic virtual keyboard, and the numerical/symbol virtual keyboard that is shown in FIGS. 9A and 9B.

The character data 336 is data to be used for generating character image data that is generated by the character generator 24 and includes character data temporarily stored in the buffer for a character being selected 324 and the buffer for character decision 326.

The first touch flag 338 is a flag that determines whether or not it touches (in contact with) the touch panel 36. For example, the first touch flag 338 is configured by a one bit register. When the first touch flag 338 is established (switched on), a data value “1” is set in the register and when the first touch flag 338 is not established (switched off), a data value “0” is set in the register. In addition, the second touch flag 340 is a flag that determines whether or not a touch (brought in contact) was performed for the determining operation. The configuration of the second touch flag 340 has the same configuration as the first touch flag 380; hence, the detailed explanation is omitted for simplification.

In other words, the first touch flag 338 is used in order to determine whether or not operations of sliding to select a character key to be focused from the virtual keyboard, or operations of touching and releasing to change the display size of the virtual keyboard have are performed and the second touch flag 340 is used in order to determine whether or not a touch is performed in order to determine a character being selected.

Although the illustration is omitted, the data storage region 304 stores image files and the like and is provided with other counters or flags necessary for the operation of the mobile terminal 10. For each flag, “0” is set in the initial state.

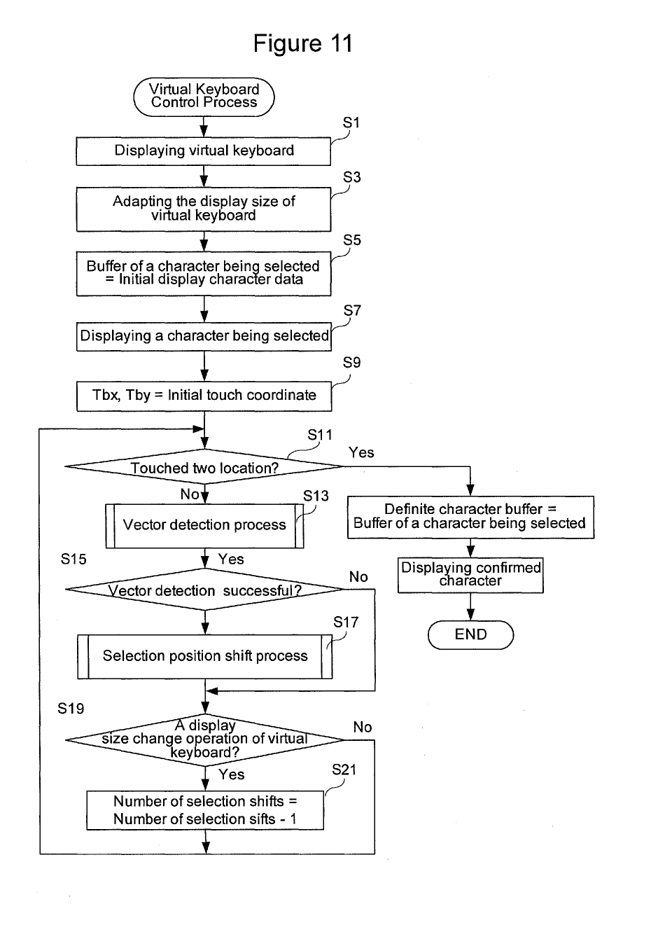

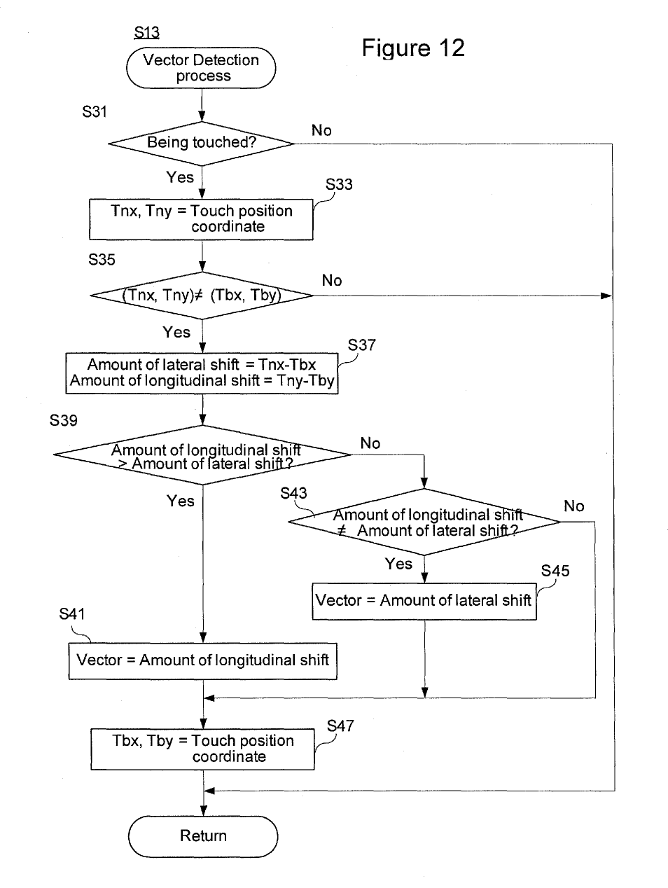

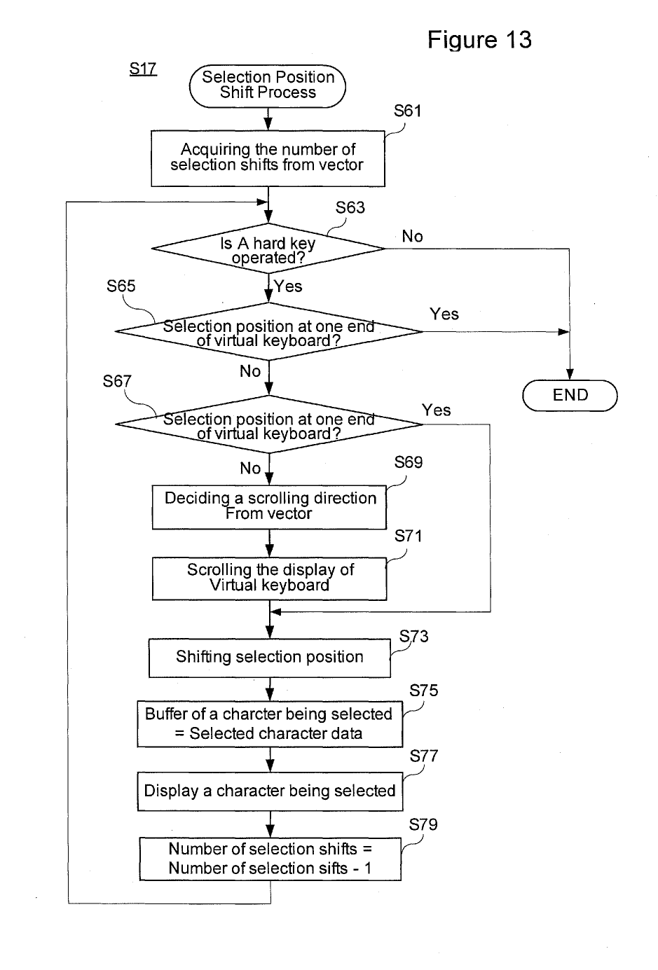

The CPU 20 executes, in parallel, a plurality of tasks including a virtual keyboard control process that is shown in FIG. 11, a vector detection process that is shown in FIG. 12, a selection position shift process that is shown in FIG. 13 and the like under the control of a real time OS such as ITRON, Symbian, and Linux.

For example, when the user executes an email function of the mobile terminal 10 and performs an operation in order to compose an email text, the CPU 20 starts the virtual keyboard control process and the virtual keyboard is displayed in a step S1 as shown in FIG. 11. That is, a Hiragana virtual keyboard that is shown in FIG. 3 is displayed in the virtual keyboard display region 46 in the state in which a character key “mi” is focused. The CPU 20 that executes the step S1 functions as a display means.

Then, in a step S3, the display size of the virtual keyboard is adapted. That is, the display size is adapted such that the display size of the virtual keyboard is accommodated in the range of the virtual keyboard display region 46. More specifically, the CPU 20 adapts such that the lateral width of the virtual keyboard matches the lateral width of the virtual keyboard display region 46. In addition, in the step S3 process, the display size of the virtual keyboard may be set into an initial display size that is previously set by the user. That is, the CPU 20 for executing the step S3 functions as an adapting means and is capable of performing the initial setting for the display size of the virtual keyboard.

Then, in a step S5, the buffer for a character being displayed 324 is caused to temporarily store initial display character data. That is, as shown in FIG. 3, the buffer for a character being selected is caused to temporarily store the character data of “mi” that is included in the character data 336. In a step S7, a character being selected is displayed. That is, a character key of “mi” that is focused in the initial state is displayed in the character display region 44. More specifically, the CPU 20, by delivering the character data temporarily stored in the buffer for a character being selected 324 to the character generator 24 and by controlling the LCD driver 26, causes the LCD monitor 28 to display a character corresponding to the character data that has temporarily been stored in the buffer for a character being selected 324. That is, if the character data of “mi” of the buffer for a character being selected 324 is temporarily stored, the character “mi” being selected is displayed in the LCD monitor 38.

In a step S9, in variables Tbx and Tby, an initial touch position coordinate is set. The variable Tbx is a variable for storing an lateral coordinate of a previously touched position and the variable Tby is a variable for storing an ordinate of a previously touched position. The variables Tbx and the Tby are primarily used in the vector detection process, which is a sub-routine. In the step S9, a coordinate that shows the center of the character display region 44 is also set as the initial touch position coordinate in the variables Tbx and Tby. When the first touch flag 338 is switched on initially, the touched point when it is touched for the first time may be defined to be the initial touch position coordinate, and the process of setting the initial touch position coordinate at the variables Tbx and the Tby may be executed when the touch is performed for the first time.

In a step S11, whether or not the touch is performed at two locations is determined. That is, whether or not the first touch flag 338 and the second touch flag 340 are switched on is determined. The CPU 20 for executing the process of the step S11 functions as a touch detection means. That is, if it is YES in the step S11 and if both the first touch flag 338 and the second touch flag 340 are not switched on, the operation proceeds to a step S23. In contrast, if it is NO in the step S11, that is, if both the first touch flag 338 and the second touch flag 340 are switched off or if only the first touch flag 338 is switched on, the vector detection process is executed in a step S13. The vector detection process is omitted here in order to explain the vector detection process that is shown in FIG. 12 in detail, using a flow chart.

In a step S15, whether or not the vector detection is successful is determined. That is, in the process of the step S13, whether or not the vector is detected, resulting from sliding with respect to the character display region 44, is determined. If it is NO in the step S15, the operation proceeds to a step S19 unless the vector is detected. In contrast, if it is YES in the step S15, the selection position shift process is executed in a step S17. The selection position shift process is omitted here in order to explain the selection position shift process that is shown in FIG. 13, using a flow chart.

Then, in the step S19, whether or not it is the operation to change the display size of the virtual keyboard is determined. For example, whether or not the touch-and-release is performed with respect to the character display region 44 is determined. If it is NO in the step S19, that is, if it is not the operation to change the display size, it returns to the step S11. In contrast, if it is YES in the step S19, that is, if the operation is to change the display size, the display size of the virtual keyboard is changed in the step S21 and the operation returns to the step S11. That is, in the step S21, the display size of the virtual keyboard is made so as to be larger or smaller. The CPU 20 that executes the process of the step S21 functions as a changing means.

Here, if an operation to determine a character is performed and if it is determined to be YES in the step S11, in the step S23, the buffer for character decision 326 is caused to temporarily store the character data that has temporarily been stored in the buffer for a character being displayed 324. That is, if character data of “ki” is temporarily stored in the buffer for a character being displayed 324, the character data of “ki” is temporarily stored in the buffer for character decision 326. In the step S23, the background color of a character key being focused is colored in red. The CPU 20 that executes the process of the step S23 functions as a character determining means.

Then, in a step S25, the determined character is displayed and the virtual keyboard control process ends. That is, in the step S25, character data that is temporarily been stored in the buffer for character decision 326 is displayed on the LCD monitor 28. When the process of the step S25 ends, so as to return to the step S11, it may be set such that other character key can be focused.

FIG. 12 is a flow diagram showing a vector detection process in the step 13 (referring to FIG. 11). When the process of the step S13 is executed, the CPU 20 determines whether or not a touch has been performed in a step S31. The CPU 20 that executes the process of the step S31 functions as the touch detection means. That is, whether or not the first touch flag 338 is switched on is determined. In contrast, if it is NO in the step S31, or if the touch is not performed, the vector detection process ends and the operation returns to the virtual keyboard control process. If it is YES in the step S31, or if the touch is performed, variables Tnx and Tny are set for the touch position coordinate in a step S33. That is, the variables Tnx and Tny are set for the current touch position coordinate. The variable Tnx is a variable for storing the lateral coordinate of the current touch position and the variable Tny is a variable for storing the ordinate of the current touch position.

Then, in a step S35, whether or not each of the variables Tnx and Tny is different from each of the variables Tbx and Tby is determined. That is, whether or not the current touch position is different from the previous touch position is determined. If it is NO in the step S35, or if the current touch position and the previous touch position are the same, the vector detection process ends and the operation returns to the virtual keyboard control process. In contrast, if it is YES in the step S35, or if the current touch position and the previous touch position are different, the amount of the lateral shift and the amount of the longitudinal shift are calculated in a step S37, based on the variables Tnx, Tny and the variables Tbx, Tby. That is, the amount of the lateral shift is calculated based on the Equation shown in Equation 3 and the amount of the longitudinal shift is calculated based on the Equation shown in Equation 4.

Tnx−Tbx=Amount of lateral shift Equation 3

Tny−Tby=Amount of longitudinal shift Equation 4

Then, in a step S39, whether or not the amount of the longitudinal shift is greater than the amount of the lateral shift is determined. That is, absolute values of the amount of the lateral shift and the amount of the longitudinal shift that are calculated are compared in order to determine whether or not the amount of the longitudinal shift is greater than the amount of the lateral shift. If it is NO in the step S39, or if the amount of the longitudinal shift is not greater than the amount of the lateral shift, the operation proceeds to a step S43. In contrast, if it is YES in the step S39, or if the amount of the longitudinal shift is greater than the amount of the lateral shift 21, the vector is defined to be the amount of the longitudinal shift in a step S41. That is, the direction of the vector is corrected to the vector in the longitudinal direction. If the amount of the longitudinal shift is positive, the direction of the vector is in the downward direction and if the symbol of the longitudinal shift is negative, the direction of the vector is in the upward direction.

In the step S43, whether or not the amount of the longitudinal shift and the amount of the lateral shift are different is determined. That is, whether or not the absolute values of the amount of the lateral shift and the amount of the longitudinal shift that are calculated are different is determined. If it is NO in the step S43, or if the amount of the lateral shift and the amount of the longitudinal shift match, because the angle of the vector with respect to the lateral coordinate is 45 degrees, the operation proceeds to a step S47 without correcting the direction of the vector. In contrast, if it is YES in the step S43, or if the amount of the lateral shift and the amount of the longitudinal shift are different, the vector is defined to be the amount of the lateral shift in a step S45. That is, if the amount of the longitudinal shift is greater than the amount of the lateral shift, the direction of the vector is corrected to the vector in the lateral direction. If the symbol of the amount of the lateral shift is positive, the direction of the vector is in the right direction and if the symbol of the amount of the lateral shift is negative, the direction of the vector is in the left direction. In addition, the CPU 20 that executes the processes from the step S39 to the step S45 functions as a correction means.

In the step S47, the variables Tbx and Tby are set for the touch position coordinate and the vector detection process ends before returning to the virtual keyboard control process. That is, the current touch position is stored as the previous touch position for the subsequent vector detection process.

FIG. 13 is a flow diagram showing a selection position shift process in the step 17 (referring to FIG. 11). When the process of the step S17 is executed, in a step S71, the CPU 20 acquires the number of the selection shifts from the vector. That is, based on the Equation shown in Equation 1, the number of the selection shifts is acquired based on the vector that is corrected either in the step S41 or the step S45. Then, in the step S63, whether or not the number of the selection shifts is greater than 0 is determined. That is, processes following the step S65 determine whether or not the number of the selection shifts already reached 0. If it is NO in the step S63, or if the number of the position shifts is 0, the selection position shift process ends and the operation returns to the virtual keyboard control process.

In contrast, if it is YES in the step S63, or if the number of the selection shifts exceeds one, whether or not the selection position in the step S65 is at one end of the virtual keyboard is determined. That is, whether or not the character key that is focused is at one end of the virtual keyboard is determined. More specifically, based on the virtual keyboard coordinate data 330, whether or not the focused character key is located at one end of the virtual keyboard is determined. If it is YES in the step S65, or if the selection position is located at the one end of the virtual keyboard, the selection position can no longer be shifted; therefore, the selection position shift process ends and the operation returns to the virtual keyboard control process. In contrast, if it is NO in the step S65, or if the selection position is not at one end of the virtual keyboard, in the step S67, whether or not the destination of the shift is within the screen is determined. That is, whether or not the character key to be focused next is included in the display range coordinate data 332 is determined.

If it is YES in the step S67, or if the destination of the shift is within the screen, the operation proceeds to a step S73. In contrast, if it is NO in the step S67, or if the destination of the shift is not within the screen, the scrolling direction is determined based on the direction of the vector in the step S69. That is, a scrolling direction is determined based on the left, right, upward, and downward directions. For example, if the direction of the vector is in the downward direction, the scrolling direction is also in the downward direction. If the direction of the vector is in the right direction, the scrolling direction is also in the right direction. Then, in a step S71, the display of the virtual keyboard is scrolled. In other words, as shown FIGS. 8A and 8B, if the character key that is focused is at one end of the virtual keyboard being displayed and if the direction of the vector is in the downward direction, the display of the virtual keyboard is scrolled in the downward direction. The CPU 20 that executes the process of the step S71 functions as a scrolling means.

Then, in a step S73, the selection position is shifted. That is, the character key to be focused is shifted by the amount of one according to the direction of the vector that is corrected. For example, referring to FIG. 4, if the focused character key is “mi” and when it is slid such that the direction of the vector is in the right direction, first, the selection position shifts to the right by the amount of one; therefore, a character key of “hi” is focused. Then, in the step S73, the background color of the focused character key is colored in pale yellow. In a step S75, the buffer for a character being selected 324 is caused to temporarily store the selected character data. That is, if the character key of “hi” is selected, the character data of “hi” is temporarily stored in the buffer for a character being selected 324. In the step S75, the background color of the character key to be focused is colored in yellow. The CPU 20 that executes the process of the step S75 functions as a character selection means.

Then, in a step S77, the character being selected is displayed. That is, as is the case in the step S7, a character corresponding to the focused character key is displayed as a character being displayed in the character display region 44. The CPU 20 that executes the process of the step S77 functions as a character display control means. Then, in a step S79, the number of the selection shifts is reduced by the amount of one and the operation returns to the step S63. That is, in the step S63, because the selection position of the step S73 is shifted by the amount of one, the number of the selection shifts is reduced by one.

In other words, as shown in FIG. 4, when it is slid with respect to the character display region 44, processes from the step S63 to the step S79 are repeatedly executed until the number of the selection shifts reaches 0. Based on this, the character data that are temporarily stored in the buffer for a character being displayed 324 are updated and character images corresponding to the character data that is updated are sequentially displayed.

### Second Embodiment

In a SECOND EMBODIMENT, a case in which the range in which the sliding operations are received is limited is described. In the SECOND EMBODIMENT, the configuration of the mobile terminal 10 and shown in FIG. 1, the appearance of the mobile terminal 10 shown in FIG. 2, the operational procedure shown in FIGS. 4, 5A and 5B, the display size of the virtual keyboard shown in FIG. 7, the types of virtual keyboards shown in FIGS. 9A and 9B, and the memory map shown in FIG. 10, which are all described in FIRST EMBODIMENT, are the same; therefore, overlapping explanations are omitted.

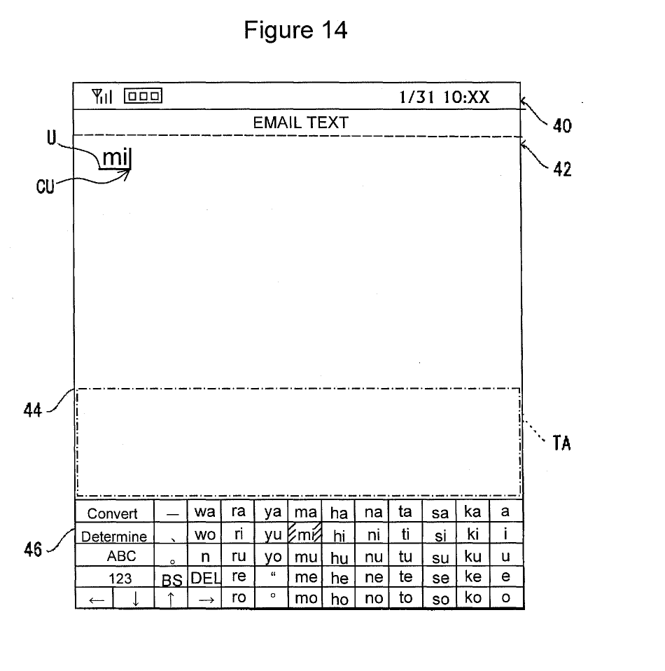

In the SECOND EMBODIMENT, as shown in FIG. 14, sliding is received within a touch region TA. More specifically, referring FIG. 14, the touch region TA included in the character display region 44 has approximately the same area as the virtual keyboard display region 46. By mapping a display coordinate of the touch region TA to a display coordinate of the virtual keyboard display region 46, respectively, a character key to be focused can be determined depending on the position to be touched in the touch region TA. Moreover, if it is slid as is, a character key that corresponds to the coordinate indicating a sliding locus is focused. For example, if the upper right of the touch region TA is touched, a character key of “a” is focused, and if slid in the downward direction to the right lower end, the character key of “i, u, e, o” are sequentially focused.

In the virtual keyboard control process shown in FIG. 11, in the vector detection process of the step S13, the touch position is detected rather than the vector detection and in the selection position shift process of the step S17, the selection position is shifted to a character key that corresponds to the detected touch position. In this manner, the vector detection process shown in FIG. 12 and the selection position shift process shown in FIG. 13 are not processed in the SECOND EMBODIMENT.

### Third Embodiment

In a THIRD EMBODIMENT, a case in which the range in which the sliding operations are received is limited is described, as similar to the SECOND EMBODIMENT. In the THIRD EMBODIMENT, the configuration of the mobile terminal 10 and shown in FIG. 1, the appearance of the mobile terminal 10 shown in FIG. 2, the operational procedure shown in FIGS. 4, 5A and 5B, the display size of the virtual keyboard shown in FIG. 7, the types of virtual keyboards shown in FIGS. 9A and 9B, the memory map shown in FIG. 10, the virtual keyboard control process shown in FIG. 11, the vector detection process shown in FIG. 12 and the selection position shift process shown in FIG. 13 which are all described in FIRST EMBODIMENT, the drawing showing the range of the touch region TA in FIG. 14 which is described in the SECOND EMBODIMENT are the same; therefore, overlapping explanations are omitted.

Unlike SECOND EMBODIMENT, in the THIRD EMBODIMENT, the display coordinate of the touch region TA and the display coordinate of the virtual keyboard display region 46 are not mapped, respectively; however, the sliding operation to shift the selection position or the like is received in the touch region TA only. By providing in twenty five colors that are different from the character display region 44 for the background color of the touch region TA, the region in which the sliding operation is received is recognized by the user. Based on this, with the touch operation with respect to the character display region 44 other than the touch region TA, the display position of the cursor CU can be changed and the determined character can be selected.

As explained above, the mobile terminal 10 includes the LCD monitor 28, and to the LCD monitor 28, the character display region 44 that can display a string of characters showing an email text and the virtual keyboard display region 46 that can display the Hiragana virtual keyboard and the like are included On the top surface of the LCD monitor 28, the touch panel 36 is provided and the touch panel 36 detects the touch operation with respect to the character display region 44 and the like. By sliding the finger within the character display region 44, the selection position within the virtual keyboard can be shifted and a character corresponding to a character key indicated by the selection position, that is, a character key that is focused are displayed in the character display region 44.

Based on this, by sliding the finger with respect to the character display region 44, the user can focus (select) a character key within the virtual keyboard easily. For cases in which the character display region 44 only is defined to be the region in which the touch operation is performed, the user does not hide the display of the virtual keyboard with his/her own finger; therefore, the user can input characters accurately.

Although the region corresponding to the character display region 44 on the touch panel 36 is defined in the above embodiments to be the region in which the touch operation is performed, the present invention is not limited thereto. In addition to the character display region 44 on the touch panel 36, the region corresponding to the virtual keyboard display region 46 and including arbitrary regions on the touch panel 36 may be defined to be the touch region for selecting characters on the virtual keyboard. In this case, because the user is able to select characters on the virtual keyboard using the wide range, the user can input characters easily.

In order to focus a character key, a special cursor may also be used. The virtual keyboard may also be used for, not limited to the e-mail function, but for a memo book function, an email address input function, an URL input function and the like. In the initial state of the virtual keyboard, it may be such that character keys other than “mi” are selected. The background color of each key in the virtual keyboard is not limited to gray, yellow, pale yellow, or red, only; however, other colors may also be used. The underline U showing a character being selected may also be other lines such as a wavy line or a double line, and the character being selected may also be represented in an italic character or in a bold character.

For the communication method of the mobile terminal 10 is not limited to the CDMA method, and the W-CDMA method, the TDMA method, the PHS method, the GSM method or the like may also be adopted. It is not limited to the mobile terminal 10, and it may be a mobile information terminal such as a personal digital assistant (PDA).

Although the character keys of the keyboard are displayed in Japanese in FIGS. 1 to 8B and 14, it is not necessarily limited to Japanese. For example, the character keys of the keyboard may also be displayed in the language suitable for each country, such as for cases of China, the character keys for the keyboard may be set in Chinese and for cases of Korea, the character keys for the keyboard may be set in Korean. That is, depending on the language of each country, the character key display of the keyboard may be changed.

The present invention provides the following embodiment. Reference symbols in brackets, supplementary explanations and the like are described in order to assist understanding; therefore, it is not limited to the reference symbols within brackets, the supplementary explanations and the like.

According to a first aspect of the invention, a touch response region is provided in a display device that displays a first display region and a second display region, and resulting from the touch operation with respect to the touch response region, characters within the virtual keyboard are selected are selected; therefore, selecting characters becomes easy and the user can easily and accurately input characters.

In a second aspect of the invention which is dependent to the first aspect of the invention, the touch response region is only provided in the region that corresponds to the first display region.

In the second aspect of the invention, since the touch response region is only provided in the region that corresponds to the first display region, a user performs a touch operation only to the first display region.

According to the second aspect of the invention, the user can accurately input characters, because the display of the virtual keyboard is not hidden by her/his own touch operation.

In a third aspect of the invention which is dependent to the first and second aspects of the invention, the mobile terminal further comprises character determining means for determining a character that is selected by the character selection means.

In the third aspect of the invention, when the determining operation for determining a selected character is performed, for example, the character determining means (20, S23) determines a character that is selected by the character selection means.

According to the third aspect of the invention, by determining a character being displayed, it is possible to continuously input the plurality of characters. That is, the user can compose texts with the mobile terminal.

In a fourth aspect of the invention which is dependent to the third aspect of the invention, the character determining means determines the character that is selected by the character selection means when the touch is detected with respect to other point by the touch operation detection means.

In the fourth aspect of the invention, the determining operation is to touch the position that is different from the touch operation for selecting a character. The character determining means determines a selected character when the position that is different from the touch operation for selecting a character is touched.

According to the fourth aspect of the invention, the user is able to determine the selected character using a touch panel.

In a fifth aspect of the invention which is dependent to the first or fourth aspect of the invention, the touch operation is a sliding operation and when the sliding operation is a sliding operation in the diagonal direction, the mobile terminal further comprises correction means for correcting as a sliding operation in the horizontal direction or in the vertical direction.

In the fifth aspect of the invention, characters of the virtual keyboard are selected by the sliding operation. When the sliding operation is performed in the diagonal direction, the correction means (20, S39-S45) corrects as the sliding operation in the horizontal direction or in the vertical direction.

According to the fifth aspect of the invention, because the direction of the sliding operation is limited either to the horizontal direction or to the vertical direction, incorrect operations can be prevented when characters are selected.

In a sixth aspect of the invention which is dependent to the first or fifth aspect of the invention, adapting means for adapting the display size of the virtual keyboard in the second display region is further provided.

In the sixth aspect of the invention, the adapting means (20, S3) adapts the display size such that, for example, the lateral width of the virtual keyboard fits the lateral width of the second display region or adapts to the previously defined display size.

According to the sixth aspect of the invention, the initial setting can be performed in the display size of the virtual keyboard.

In a seventh aspect of the invention which is dependent to the first or fifth aspect of the invention, in the second display region, a part of the virtual keyboard is displayed, and when the display of a character selected by the character selection means is at one end of the second display region, the mobile terminal further comprises scrolling means for scrolling the display of the virtual keyboard.

In the seventh aspect of the invention, with regard to the virtual keyboard, some of it is displayed in the second display region. The scrolling means (20, S71), such that the section of the virtual keyboard that is not displayed is displayed, scrolls the display of the virtual keyboard in the second display region when a character at one end of the virtual keyboard to be displayed is selected. That is, even for the virtual keyboard in which the entire section is not displayed, by scrolling the display, the section of the virtual keyboard that is not displayed can be recognized.

According to the seventh aspect of the invention, it is possible to make the display size of the virtual keyboard larger to make it easier for the user to use.

In a eighth aspect of the invention which is dependent to the seventh aspect of the invention, display size change means is further provided for changing the display size of the virtual keyboard.

In the eighth aspect of the invention, the display size change means (20, S21) changes the display size of the virtual keyboard according to the operation for changing the display size of the virtual keyboard.

According to the eighth aspect of the invention, the user can select the display size of the virtual keyboard such that the user can easily use.

In a ninth aspect of the invention which is dependent to the first or eighth aspect of the invention, a character selection means updates characters to be selected according to the touch operation and the character display control means sequentially displays each of the updated characters (S63-S79).

In the ninth aspect of the invention, when the plurality of characters are continuously selected with the sliding operation, characters to be selected by the character selection means are updated. In the second display region, each of the characters to be updated with the sliding operation is sequentially displayed.

According to the ninth aspect of the invention, the user is able to sequentially verify each of the selected characters.

Note that the entire content of the Japanese Patent Application No. 2008-277616 (date of application; Oct. 29, 2008) is incorporated in the present specification by reference.

### INDUSTRIAL APPLICABILITY

The present invention relates to mobile terminals, particularly can be used in mobile terminals with a touch panel which is used for inputting characters.

What is claimed is:

1. A mobile terminal, comprising:
a display device comprising:
a first display region operable to display a string of characters; and
a second display region operable to display a virtual keyboard;
a touch operation detection module operable to detect a touch operation in the display device;
a character selection module operable to select a character in the virtual keyboard based on the touch operation; and
a character display control module operable to display the character in the first display region.

2. The mobile terminal according to claim 1, wherein the touch operation detection module is operable to detect the touch operation in the first display region.

3. The mobile terminal according to claim 1, further comprising a character determining module operable to determine the character that is selected by the character selection module.

4. The mobile terminal according to claim 3, wherein the character determining module determines the character that is selected by the character selection module when the touch operation detection module detects another touch at another point.

5. The mobile terminal according to claim 1, wherein the touch operation comprises a sliding operation, and when the sliding operation is performed in the diagonal direction, the mobile terminal further comprises correction module operable to correct the slide operation as a sliding operation in the horizontal direction or in the vertical direction.

6. The mobile terminal according to claim 1, further comprising an adapting module operable to adapt the display size of the virtual keyboard in to the second display region.

7. The mobile terminal according to claim 1, further comprising a scrolling module operable to scroll the display of the virtual keyboard when the display of the character selected by the character selection module is at one end of the second display region, wherein a part of the virtual keyboard is displayed in the second display region.

8. The mobile terminal according to claim 7, further comprising a display size change module operable to change the display size of the virtual keyboard.

9. The mobile terminal according to claim 1, wherein the character selection module updates characters to be selected according to the touch operation, and the character display control module sequentially displays each of the updated characters.
